(19) United States
(12) Patent Application Publication
(10) Pub. No.: US 2026/0175854 A1
(43) Pub. Date: Jun. 25, 2026

(54) AUTOMATED VEHICLE CONTROL REQUIREMENTS PROCESSING USING MACHINE LEARNING MODELS

(71) Applicant: GM GLOBAL TECHNOLOGY OPERATIONS LLC, Detroit, MI (US)

(72) Inventors: Prakash M. PERANANDAM, Rochester Hills, MI (US); Prathap VENUGOPAL, Troy, MI (US); Arun ADITHTHAN, Sterling Heights, MI (US); Ramesh S, Troy, MI (US)

(21) Appl. No.: 18/921,988

(22) Filed: Oct. 21, 2024

(51) Int. Cl. B60W 50/14; B60W 50/00; G06N 20/00

(52) U.S. Cl. CPC B60W 50/14; G06N 20/00; B60W 2050/0005; B60W 2050/146; B60W 2556/10

(57) ABSTRACT

An example system for automated vehicle control requirements processing includes at least one processor configured to preprocess multiple data artifacts associated with vehicle control system requirements and including at least two different modalities, including reducing redundancy and resolving conflicts between the multiple data artifacts, determine a modality of each data artifact, create an embedding for each data artifact according to the modality of the data artifact, generate, as an output of at least one machine learning model, at least one of a message sequence chart, a finite state machine and a Gherkin use case, according to the embeddings of the multiple data artifacts, and build a unified requirements model according to the at least one of the message sequence chart, the finite state machine and the Gherkin use case, wherein the unified requirements model defines control requirements for at least one vehicle control feature.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to automated vehicle control requirement processing using machine learning models, including requirement elicitation based on artifacts having multiple modalities.

Subject matter experts often meet to brainstorm requirements for development of any systems for various devices, such as vehicle control system. The subject matter experts typically build requirements through several iterations of peer reviews. During brainstorming meetings, subject matter experts may take written nodes, create voice recordings, or generate drawings or images.

### SUMMARY

An example system for automated vehicle control requirements processing includes memory configured to store multiple data artifacts associated with vehicle control system requirements, at least one machine learning model, and computer-executable instructions, wherein the multiple data artifacts include at least two different modalities, and at least one processor configured to execute the computer-executable instructions to preprocess the multiple data artifacts including reducing redundancy among the multiple data artifacts and resolving conflicts between the multiple data artifacts, determine, for each of the multiple data artifacts, a modality of the data artifact, create an embedding for each of the multiple data artifacts according to the modality of the data artifact, generate, as an output of the at least one machine learning model, at least one of a message sequence chart, a finite state machine and a Gherkin use case, according to the embeddings of the multiple data artifacts, build a unified requirements model according to the at least one of the message sequence chart, the finite state machine and the Gherkin use case, wherein the unified requirements model defines control requirements for at least one vehicle control feature, and display the unified requirements model on a user interface of a display device.

In some examples, the at least one processor is configured to execute the computer-executable instructions to train the at least one machine learning model to output the at least one of the message sequence chart, the finite state machine and the Gherkin use case, based on historical artifact data, using supervised learning.

In some examples, the at least one processor is configured to automatically generate computer-executable instructions according to the unified requirements model, to execute the at least one vehicle control feature.

In some examples, the at least one processor is configured to execute computer-executable instructions defined according to the unified requirements model, to automatically control acceleration of a vehicle, braking of the vehicle and steering of the vehicle.

In some examples, the at least one processor is configured to analyze the unified requirements model using at least one validation tool to identify missing information in the unified requirements model.

In some examples, the at least one validation tool includes at least one of a message sequence consistency check tool, a finite state machine analyzer tool, or a Gherkin output file certifier tool.

In some examples, the different modalities of the multiple data artifacts include at least one of a text transcript, a voice recording, a drawing or image, a unified modeling language diagram, a technical specification document, a process flow diagram, or a voice of customer feedback verbatim.

In some examples, the at least one machine learning model includes a generative artificial intelligence (AI) large language model (LLM).

In some examples, creating an embedding for each of the multiple data artifacts includes creating a first embedding for a first one of the multiple data artifacts having a first modality, using a first embedding model corresponding to the first modality, and creating a second embedding for a second one of the multiple data artifacts having a second modality, using a second embedding model corresponding to the second modality.

In some examples, generating the output of the at least one machine learning model includes generating the message sequence chart. In some examples, generating the output of the at least one machine learning model includes generating the finite state machine. In some examples, generating the output of the at least one machine learning model includes generating the Gherkin use case.

An example method for automated vehicle control requirements processing includes preprocessing multiple data artifacts associated with vehicle control system requirements, wherein the multiple data artifacts include at least two different modalities, and the preprocessing includes reducing redundancy among the multiple data artifacts and resolving conflicts between the multiple data artifacts, determining, for each of the multiple data artifacts, a modality of the data artifact, creating an embedding for each of the multiple data artifacts according to the modality of the data artifact, generating, as an output of at least one machine learning model, at least one of a message sequence chart, a finite state machine and a Gherkin use case, according to the embeddings of the multiple data artifacts, building a unified requirements model according to the at least one of the message sequence chart, the finite state machine and the Gherkin use case, wherein the unified requirements model defines control requirements for at least one vehicle control feature, and displaying the unified requirements model on a user interface of a display device.

In some examples, the method includes training the at least one machine learning model to output the at least one of the message sequence chart, the finite state machine and the Gherkin use case, based on historical artifact data, using supervised learning.

In some examples, the method includes automatically generating computer-executable instructions according to the unified requirements model, to execute the at least one vehicle control feature.

In some examples, the method includes executing computer-executable instructions defined according to the unified requirements model, to automatically control acceleration of a vehicle, braking of the vehicle and steering of the vehicle.

In some examples, the method incudes analyzing the unified requirements model using at least one validation tool to identify missing information in the unified requirements model.

In some examples, the at least one validation tool includes at least one of a message sequence consistency check tool, a finite state machine analyzer tool, or a Gherkin output file certifier tool.

In some examples, the different modalities of the multiple data artifacts include at least one of a text transcript, a voice recording, a drawing or image, a unified modeling language diagram, a technical specification document, a process flow diagram, or a voice of customer feedback verbatim.

In some examples, the at least one machine learning model includes a generative artificial intelligence (AI) large language model (LLM).

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a diagram of an example system for automated vehicle system requirements elicitation using machine learning models.

FIG. 2 is a flowchart depicting an example process for automated vehicle system requirements elicitation using machine learning models.

FIG. 3 is a flowchart depicting an example process for preprocessing artifacts during the example process of FIG. 2.

FIG. 4 is a flowchart depicting an example process for ingesting artifacts by interpreting different modalities during the example process of FIG. 2.

FIG. 5 is a flowchart depicting an example process for generating user stories, message sequence charts (MSCs) and Gherkin use cases during the example process of FIG. 2.

FIG. 6 is a flowchart depicting an example process for building a unified requirements model during the example process of FIG. 2.

FIG. 7 is a flowchart depicting an example process for constructing final requirements models during the example process of FIG. 2.

FIGS. 8A and 8B are graphical representations of example recurrent neural networks for automated vehicle system requirements elicitation.

FIG. 9 is a graphical representation of layers of an example long short-term memory (LSTM) machine learning model.

FIG. 10 is a flowchart illustrating an example process for training a machine learning model.

In the drawings, reference numbers may be reused to identify similar and/or identical elements.

### DETAILED DESCRIPTION

In some example embodiments, data artifacts generated during, for example, brainstorming sessions for development of control system requirements, may be collected during meetings, from phone calls, from emails, from chat groups, etc. Machine learning models, including generative artificial intelligence (AI) models (such as large language models (LLMs)), may be deployed to process the data artifacts and generate a complete set of requirements for the control system (e.g., vehicle control system feature requirements). Example embodiments may significantly reduce a time to generate the requirements, which may be used for development of software modules, computer-executable instructions, vehicle control system features or architecture, non-transitory computer-readable media, etc.

For example, an output of the automated process may include modules for embedded systems or software architecture, which may be used for control of automated driving (e.g., automatic control of vehicle acceleration, braking, steering, etc.), or other automotive features or functionalities. In some examples the process may be completed automated without human intervention. In other examples, human administrator reviewers or the subject matter experts (SMEs) may be part of the loop in one or more (or all) steps to generate the requirements model.

In some examples, different machine learning models may be used for different data cleaning functions on the data artifacts, such as different LLMs for cleaning data artifacts having different modalities. Each type/modality of artifact (e.g., voice recording, text transcript, drawing, etc.) may be converted by a corresponding model into an embedding. The selection of embedding model may be fixed or dynamic, depending on various implementations. For example, the system may be configured to always use a semantic embedding model to convert voice recordings to numerical embedding representations, while using other model types to create embeddings for data artifacts having other modalities.

Example systems may be configured to generate requirements based on the data artifact embeddings and the prompts, such as using trained models to generate a message sequence charge output format or Gherkin use case output format, based on the embeddings. In these examples, the model may already be trained or know now to output a message sequence chart (MSC) or Gherkin format (such as based on an example prompt of “Use the provided embedding to generate a response and return the response in MSC or Gherkin format”).

In some examples, a machine learning model such as an LLM creates an initial MSC output or Gherkin use case output. A human administrator may then review and revise the output, such as by adding additional prompts information to refine the output. The LLM may then rerun to generate the additional information.

Example systems may be configured to take independent outputs of the embeddings, then consolidate them in a correct order. If information is missing (e.g., a finite state machine (FSM) is missing a state, which is explained in a different data artifact), the system may be configured to obtain information from different partial requirements from different embedding outputs, then combine together the separate requirements from individual artifacts. An ensemble retrieval technique can be utilized with various priorities while utilizing multiple embeddings.

When filling in the gap/missing information, a user may provide embeddings or weights that instruct the system where to look for additional information. As another example, the user may provide additional information through text, such as directly modifying prompts. The system may be configured to perform one or more completeness checks of a final requirements model, such as making sure that all of the FSMs or MSCs are consistent with one another. These checks may be an iterative process, including human review, use of validation tools, use of an LLM for confirmation, etc.

Some example embodiments provide advantages of facilitating independent contributions from subject matter experts, increasing ease of manual efforts, reducing a number of iterations, and end to end traceability enabling a directed point of resolution. This may reduce resources and time needed for the iterative process of requirements elicitation, may reduce individual misinterpretation of artifacts, and may reduce dependency on individual subject matter experts.

In some examples, the system extracts contents effectively from heterogeneous artifacts from various team members, and provides an automatic comprehensive summarization of the contents in an artifact using, for example, Mixture of Experts (MoE) Gen-AI models with specified weights. Example systems may facilitate effective splitting of artifact contents, and vectorization-based clustering, using a selected embedding model.

Heuristics guided hierarchical prompt templates may contain improved or optimized configurations, contexts, Ensemble RAG and chain of thought (CoT) prompting techniques for generating high quality use cases and requirements models of the given content, and consolidation of individual use case and requirements model contents to build a comprehensive and complete set of use cases and requirements models (such as Gherkin style use cases, MSCs, FSMs, etc.). In some examples, the system includes a meta data annotation guided traceability mechanism.

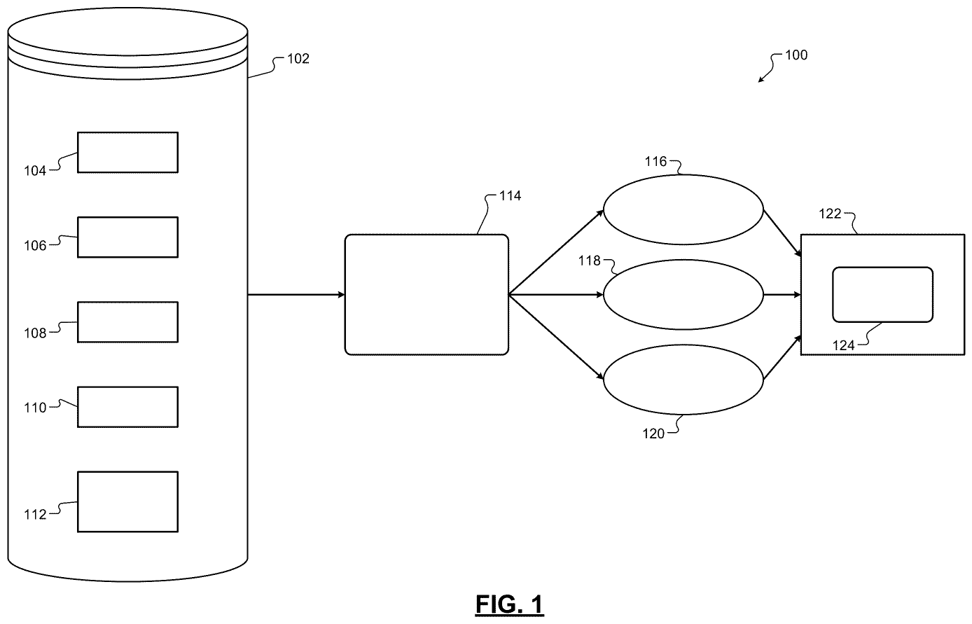

Referring now to FIG. 1, an example system 100 includes a database 102 (or other suitable memory, server, cloud storage, etc.), configured to store plausible use case brainstorming artifacts. The brainstorming artifacts may be in a variety of formats, such as text transcripts 104, voice recordings 106, drawings/images 108, UML diagrams 110, voice of customer feedback 112, etc. Other example embodiments may include more or less (or other) types of data artifacts.

A generative AI requirements elicitation module 114 accesses the data artifacts from the database 102, and generates one or more outputs, as explained further below. For example, the requirements elicitation module 114 may generate requirements models 116 (such as MSCs, FSMs, etc.), bookkeeping records 118, user stories or requirements 120 in a Gherkin format, etc.

The system 100 also includes a display 122 including a user interface 124, which may be configured to display one or more of the requirements models 116, bookkeeping records 118, or user stories or requirements 120. In some examples, the requirements models 116 or the user stories or requirements 120 may be used to automatically generate computer-executable instructions for executing software (e.g., non-transitory computer-readable media). For example, the requirements model may be associated with a vehicle control feature, and a processor may be configured to execute software created based on the requirements model to control automated driving of the vehicle, such as automatic control of vehicle acceleration, braking and steering.

In some examples, the requirements elicitation module 114 may be configured to ingest different data artifacts from brainstorming sessions, combine and cluster them, and extract data and develop requirements in the Gherkin format. The requirements elicitation module 114 may maintain traceability of the source and content (e.g., bookkeeping), for easy access to ask for refinement or missing information, or to output clusters of relevant topics from different sources. In some examples, the system may build models, such as a message sequence chart (MSC) or a finite state machine (FSM).

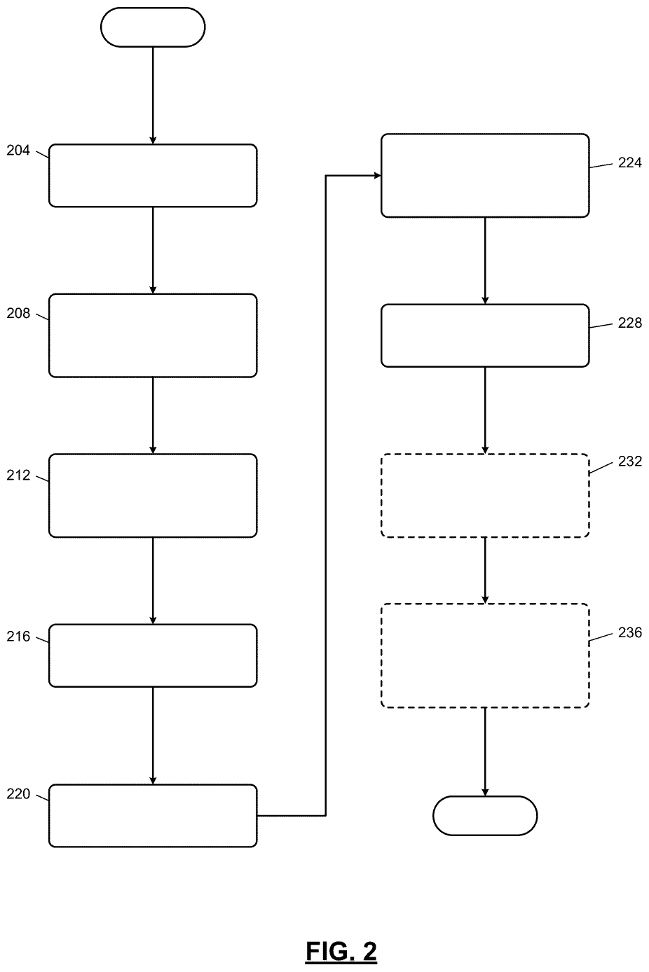

FIG. 2 is a flowchart depicting an example process for automated vehicle system requirements elicitation using machine learning models. The example process of FIG. 2 may be performed by, for example, the requirements elicitation module 114 of FIG. 1. At 204, the process begins by obtaining plausible use case brainstorming artifacts having different data formats.

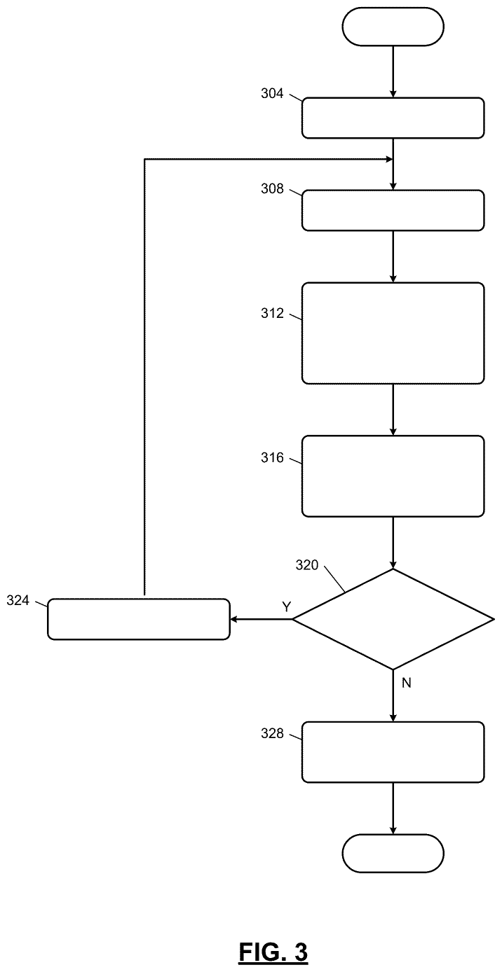

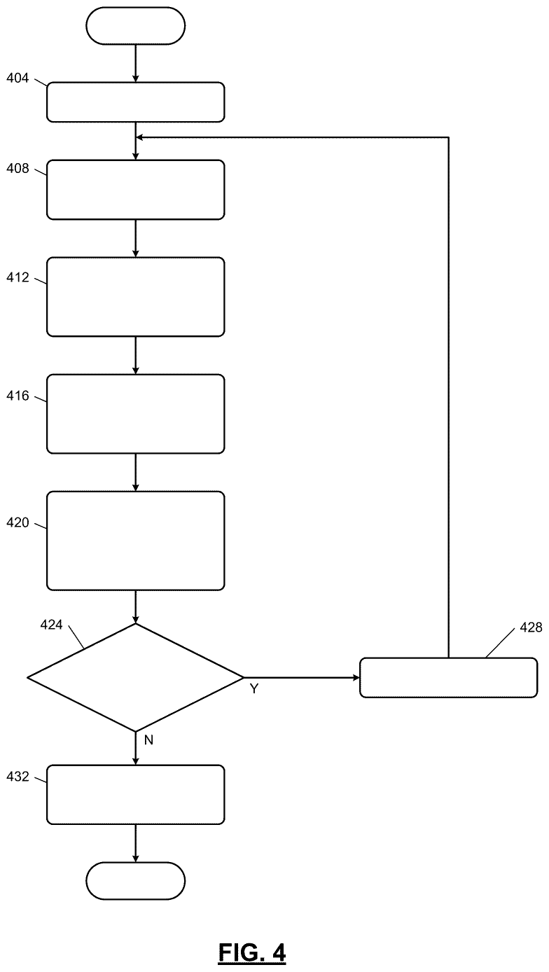

At 208, control preprocesses the artifacts, including cleaning data, reducing redundancy and resolving conflicts. Further details of preprocessing the artifacts are described below with reference to FIG. 3. At 212, control ingests artifacts by interpreting different modalities and creating embeddings for the artifacts. Further details of creating the embeddings are described below with reference to FIG. 4.

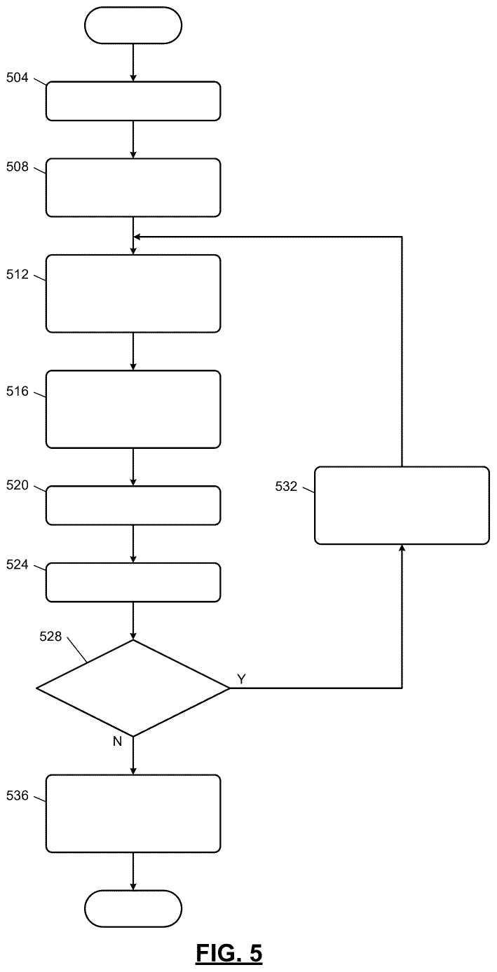

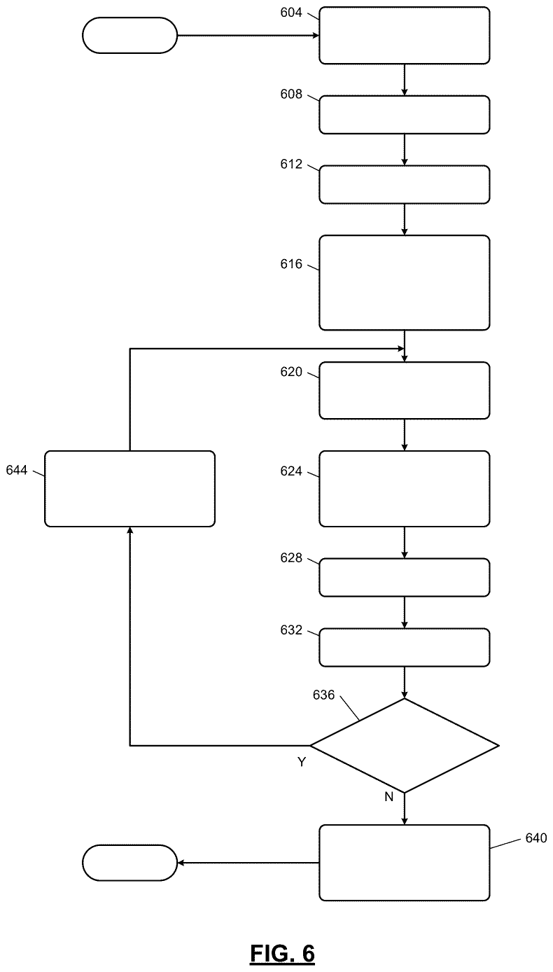

At 216, control generates user stories, and fixes Gherkin use cases and MSCs. Further details of generating the user stories are discussed below with reference to FIG. 5. At 220, control builds a unified requirements model, which may include MSCs, FSMs, Gherkin use cases, etc. Further details of creating the unified requirements model are described below with reference to FIG. 6.

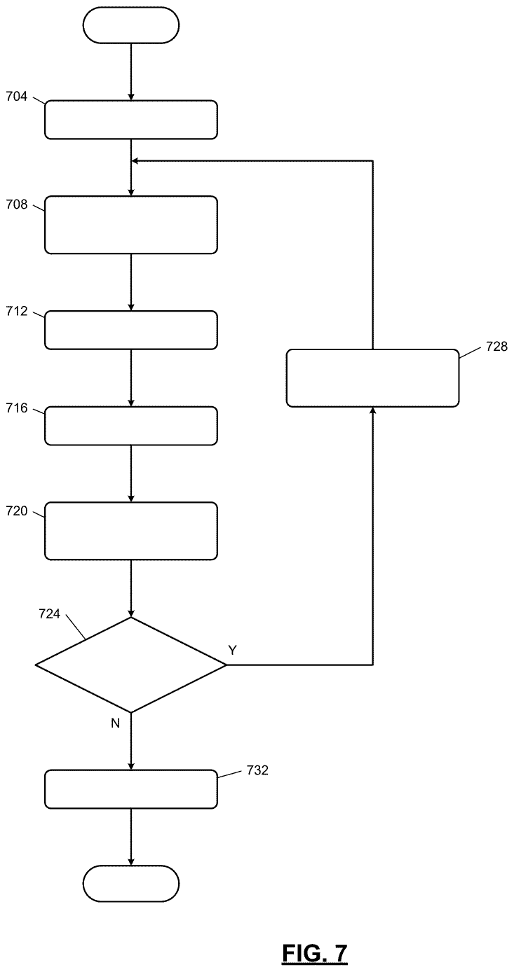

At 224, control constructs a final requirements model, which may include refinement based on missing data and validation tools. Further details of constructing the final requirements model are discussed below with reference to FIG. 7.

Control may display the final requirements model on a user interface of a display screen, at 228. Optionally, control may build automated software modules for execution by a processor, based on the final requirements models, at 232. In some examples, the system optionally uses the final requirements models, and computer-executable instructions based on the final requirements models, to control vehicle features (such as automated acceleration, braking and steering of a vehicle), at 236.

FIG. 3 is a flowchart depicting an example process for preprocessing artifacts during the example process of FIG. 2. The example process of FIG. 3 may be performed by, for example, the requirements elicitation module 114 of FIG. 1. At 304, the process begins by selecting a first artifact from an artifact list.

At 308, control determines a format of a selected artifact, such as a text transcript, a voice recording, a drawing or image, a unified modeling language (UML) diagram, a voice of customer (VOC) feedback, etc. Control then generates a textual output at 312, based on the determined format of the selected artifact, using a machine learning model.

For example, the system may include multiple individual multi-modal models, which each correspond to a different type of artifact format. A multi-modal model may be configured to simultaneously process different data types, such as text, images, audio, video, etc. A text artifact LLM may be trained to process text transcript artifacts, a voice recording artifact LLM may be trained to process audio voice recordings, etc.

As an example, during a vending machine system functionality brainstorming session, multiple speakers may provide ideas for different vending machine functions. Voice recordings of the speakers may be supplied to an LLM, to generate textual outputs such as:

```
{
Document Meta Data
  - Source: Teams Call
  - Output: Doc1
  - Day: 3^{rd} June 20XX
  - Time 10:00 to 11:30 AM
  - Meeting Title: <Title>
  - Attendance: <Person1, ...>
}
{
Content Meta Data
  Statement1: Person1
}
{
Content Meta Data
  Statement2: Person3
}
```

At 316, control generates a comprehensive summary of text using one or more machine learning models. The comprehensive summary may include metadata. For example, textual output from the multi-modal LLMs (e.g., after data format conversion of the artifacts), may be supplied to a data cleaning LLM such as ChatGPT, LLaMA, etc.

The comprehensive summary of given text of the artifact may result in storage size reductions. Example summary data objects may be in a format such as:

```
{
Document Meta Data
  - Source: Doc1
  - Output: LLM Summarization
  - LLM Model: ChatGPT 4.0
  - Day: 4^{th} June 20XX
  - ...
}
{
Content Meta Data
  Ref: Statement1:
    Doc1.Statement1
}
{
Content Meta Data
  Ref: Statement1:
    Doc1.Statement4,
    Doc1.Statement3, ...
}
```

At 320, control determines whether there are any remaining artifacts on the list to be preprocessed. If so, control proceeds to 324 to select a next artifact from the list, and returns to 308 to determine a format of the next selected artifact. Once all artifacts are preprocessed at 320, control proceeds to 328 to supply the preprocessed artifacts for artifact ingestion.

FIG. 4 is a flowchart depicting an example process for ingesting artifacts by interpreting different modalities during the example process of FIG. 2. The example process of FIG. 4 may be performed by, for example, the requirements elicitation module 114 of FIG. 1. At 404, the process begins by selecting a first preprocessed artifact from the list.

At 408, control determines a format of the selected preprocessed artifact. Control then splits the artifact contents at 412, such as into different voice statements, different text statements, different transactions, different chunks, etc., based on the determined format. The artifact content splitting may be heuristic based, empirical based, etc., such as content based grouping of sentences, or sentence by sentence splitting.

For example, different formats of preprocessed artifacts may be split in different ways, such as splitting voice transcripts into different voice statements, splitting text transcripts into different text statements, using different content splitting approaches for engineering artifacts such as UML diagrams, technical specifications, finite state machine (FSMs), process flow diagrams, customer verbatims, legacy data, feedback, VoC, etc. In some examples, semantic chunking may be used on various formats of preprocessed artifacts.

At 416, control selects an embedding neural network model corresponding to the determined format. Control then supplies the split artifact contents to the selected neural network model at 420, to generate artifact embeddings. For example, different neural networks or other algorithms may be designed or trained to create embeddings for different types of preprocessed artifact statements, chunks, etc. Once a format is determined for the artifact, a corresponding embedding model is selected for vectorization (e.g., via individual embedding model calls).

Embeddings may be created through neural networks, to capture complex relationships and semantics into dense vectors that can be projected into a proper high-dimensional vector space. The meaning of a data point may be implicitly defined by its position on the vector space. The spatial properties may then be used for nearest neighbor searches to retrieve semantically similar items based on spatial closeness.

At 424, control determines whether any preprocessed artifacts remain from the list. If so, control proceeds to 428 to select a next preprocessed artifact from the list, and returns to 408 to determine a format of the next selected preprocessed artifact. Once all preprocessed artifacts from the list have been processed to generate embeddings, control proceeds to 432 to supply the preprocessed artifact embeddings for generation of user stories, message sequence charts (MSCs), FSMs, Gherkin use cases, etc.

FIG. 5 is a flowchart depicting an example process for generating user stories, message sequence charts (MSCs) and Gherkin use cases during the example process of FIG. 2. The example process of FIG. 5 may be performed by, for example, the requirements elicitation module 114 of FIG. 1. At 504, the process begins by obtaining artifact embeddings.

At 508, control generates templated prompts based on the artifact embeddings. For example, the templated prompts may be used for prompting a generative artificial intelligence (AI) model, such as an LLM, to generate message sequence charts, finite state machines, Gherkin use cases, etc. The templated prompts may be automatically generated based on the embeddings corresponding to the artifacts, using one or more models, algorithms, etc.

At 512, control builds MSCs, FSMs, Gherkin use cases, etc., by supplying the artifact embeddings to individual multi-modal LLMs, using calls based on the generated prompts. For example, different LLMs may be trained to generate different types of outputs (e.g., MSCs, FSMs, Gherkin use cases), and the prompts may be supplied to the different LLMs to generate a desired output corresponding to the LMMs and/or prompts.

At 516, control automatically prepares a question list based on the built MSCs, FSMs, Gherkin use cases, etc. The question list may be generated by one or more models, algorithms, etc., based on identified conflicts in the MSCs, FSMs, Gherkin use cases, etc., based on identified missing information in the MSCs, FSMs, Gherkin use cases, etc.

Control then transmits the question list to an administrator at 520. This may allow a human in the loop to provide feedback, or modify prompts to more accurately generate desired requirements models. At 524, control receives a response from the administrator.

If the response indicates that additional text should be added to prompts at 528, control proceeds to 532 to generate updated prompts according to additional text received from the administrator, and returns to 512 to re-build the MSCs, FSMs, Gherkin use cases, etc., based on the updated prompts. This may be repeated a specified number of times, or until a response from the administrator indicates that no further modifications or additions are needed. In that case, control proceeds to 536 to supply the MSCs, FSMs, Gherkin use cases, etc., for building a unified requirements model.

As an example of prompt generation for a vending machine system, assuming a “config”, control may convert beverage vending machine requirements given in “embeddings” and “text” into formats defined in “syntax” with the “context” in mind. An administrator may then add text such as “For the given scenario include options for the user to add cream and sugar with some levels.”

FIG. 6 is a flowchart depicting an example process for building a unified requirements model during the example process of FIG. 2. The example process of FIG. 6 may be performed by, for example, the requirements elicitation module 114 of FIG. 1. At 604, the process begins by obtaining multiple built MSCs, FSMs, Gherkin use cases, etc., for multiple artifacts.

Control then retrieves artifact embeddings at 608, and applies weights to the embeddings at 612, and utilizes an ensemble method to retrieve information. For example, customer VoC embeddings may be given a higher weight for user interface features, diagram embeddings may be given a higher weight for models, etc.

At 616, control generates prompts based on multiple MSCs, FSMs, Gherkin use cases, etc., and weighted artifact embeddings. In some examples, hierarchical prompt engineering may be used based on templates, ensemble weights, context and configuration creations, etc.

Control then builds a unified MSC, FSM, Gherkin use case, etc., via an LLM call. For example, a consolidated/unified requirements builder for different source artifacts may be implemented as an LLM (or other suitable machine learning model or algorithm), which may be specialized for creating engineering artifacts.

At 624, control automatically prepares a questions list based on the unified MSC/FSM/Gherkin use cases. Control then transmits the questions list to an administrator at 628 for review and inputs, and receives a response from the administrator at 632.

If the response indicates that additional text should be added or modified at 636, control proceeds to 644 to generate updated prompts according to the additional text received from the administrator. Control then returns to 620 to build a unified MSC, FSM and/or Gherkin use case based on the updated prompts. After a set number of updates, or when the administrator response indicates that no further additions or modifications are desired, control proceeds to 640 to supply the unified MSC, FSM, Gherkin use cases, etc., for construction of a final requirements model.

In some examples, hierarchical prompt engineering may include, assuming “config”, comprehending and consolidating beverage vending machine requirement given in “<doc1>, <doc2> . . . ,” to formats defined in “syntax.” Control may then consider identified gaps and improvements, with additional information in “embeddings.” Inputs to questions from administrators may be captured in a text file, and control may consider inputs from “text” to fill the gaps and improvements, where additional information in “embeddings” is based on formats defined in “syntax.”

FIG. 7 is a flowchart depicting an example process for constructing final requirements models during the example process of FIG. 2. The example process of FIG. 7 may be performed by, for example, the requirements elicitation module 114 of FIG. 1. At 704, the process begins by obtaining unified MSC, FSM and/or Gherkin use cases.

At 708, control executes a model completeness check using a validation tool. Control then applies an MSC consistency checker tool at 712, if the system includes a unified MSC. At 716, control applies an FSM analyzer tool, if the system includes a unified FSM. At 720, control applies a Gherkin output file checker, if the system includes unified Gherkin use cases.

At 724, control determines whether there were any inconsistencies identified during the consistency checks. If so, control proceeds to 728 to modify inconsistent data (e.g., via a change control board), and returns to 708 to repeat the sequence of consistency checks. When the checks do not identify any inconsistencies, control proceeds to 732 to output a final requirements model.

For example, control may analyze for gaps, completeness, etc., and refine based on artifact information that was missed or could not be considered in earlier versions of the draft models. Formal tools may be used to validate consistency of the requirements model (such as an LLM analyzer), which may be combined with manual checks (e.g., via a change control board (CCB)).

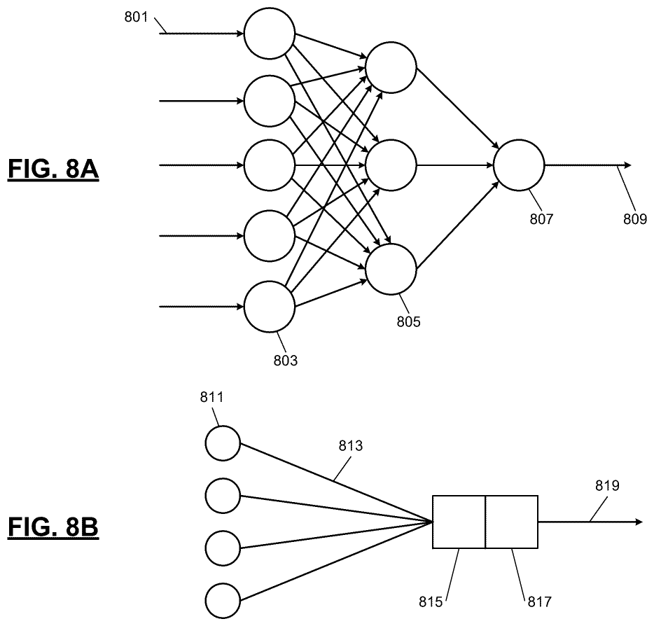

FIGS. 8A and 8B show an example of a recurrent neural network used to generate models such as those described above, using machine learning techniques. Machine learning is a method used to devise complex models and algorithms that lend themselves to prediction (for example, patient and provider matching predictions). The models generated using machine learning, such as those described above, can produce reliable, repeatable decisions and results, and uncover hidden insights through learning from historical relationships and trends in the data.

The purpose of using the recurrent neural-network-based model, and training the model using machine learning as described above, may be to directly predict dependent variables without casting relationships between the variables into mathematical form. The neural network model includes a large number of virtual neurons operating in parallel and arranged in layers. The first layer is the input layer 803 and receives raw input data 801. Each successive layer modifies outputs from a preceding layer and sends them to a next layer. The last layer is the output layer 807 and produces output 809 of the system.

FIG. 8A shows a fully connected neural network, where each neuron in a given layer is connected to each neuron in a next layer. In the input layer, each input node is associated with a numerical value, which can be any real number. In each layer, each connection that departs from an input node has a weight associated with it, which can also be any real number (see FIG. 8B). In the input layer, the number of neurons equals the number of features (columns) in a dataset. The output layer may have multiple continuous outputs.

The layers between the input layers 803 and output layers 807 are hidden layers 805. The number of hidden layers can be one or more (one hidden layer may be sufficient for most applications). A neural network with no hidden layers can represent linear separable functions or decisions. A neural network with one hidden layer can perform continuous mapping from one finite space to another. A neural network with two hidden layers can approximate any smooth mapping to any accuracy.

The number of neurons can be optimized. At the beginning of training, a network configuration is more likely to have excess nodes. Some of the nodes may be removed from the network during training that would not noticeably affect network performance. For example, nodes with weights approaching zero after training can be removed (this process is called pruning). The number of neurons can cause under-fitting (inability to adequately capture signals in dataset) or over-fitting (insufficient information to train all neurons; network performs well on training dataset but not on test dataset).

Various methods and criteria can be used to measure the performance of a neural network model. For example, root mean squared error (RMSE) measures the average distance between observed values and model predictions. Coefficient of Determination (R2) measures correlation (not accuracy) between observed and predicted outcomes. This method may not be reliable if the data has a large variance. Other performance measures include irreducible noise, model bias, and model variance. A high model bias for a model indicates that the model is not able to capture true relationship between predictors and the outcome. Model variance may indicate whether a model is stable (a slight perturbation in the data will significantly change the model fit). The neural network can receive inputs, e.g., vectors, which can be used to generate models that can be used for automated vehicle system requirements elicitation.

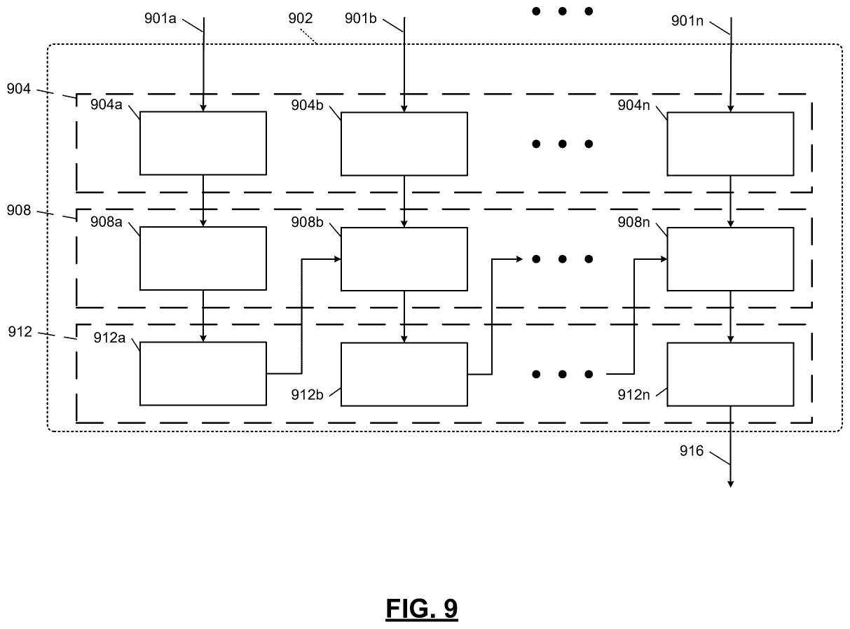

FIG. 9 illustrates an example of a long short-term memory (LSTM) neural network 902 used to generate models such as those described above, using machine learning techniques, although other example embodiments may include other types of machine learning models including transformer layers, other model topologies, etc. The generic example LSTM neural network 902 may be used to implement a machine learning model, and various implementations may use other types of machine learning networks (such as transformer layers, other model topologies or architectures, etc.). The LSTM neural network 902 includes an input layer 904, a hidden layer 908, and an output layer 912. The input layer 904 includes inputs 904a, 904b . . . 904 n, which may correspond to input data 901 a, 901a . . . 901 n. The hidden layer 908 includes neurons 908 a, 908b . . . 908 n. The output layer 912 includes outputs 912 a, 912b . . . 912 n.

Each neuron of the hidden layer 908 receives an input from the input layer 804 and outputs a value to the corresponding output in the output layer 912. For example, the neuron 908a receives an input from the input 904a and outputs a value to the output 912a. Each neuron, other than the neuron 908a, also receives an output of a previous neuron as an input. For example, the neuron 908b receives inputs from the input 904b and the output 912a. In this way the output of each neuron is fed forward to the next neuron in the hidden layer 908. The last output 912n in the output layer 912 outputs a probability 916 associated with the inputs 904a-904n. Although the input layer 804, the hidden layer 908, and the output layer 912 are depicted as each including three elements, each layer may contain any number of elements.

In various implementations, each layer of the LSTM neural network 902 must include the same number of elements as each of the other layers of the LSTM neural network 902. In some example embodiments, a convolutional neural network may be implemented. Similar to LSTM neural networks, convolutional neural networks include an input layer, a hidden layer, and an output layer. However, in a convolutional neural network, the output layer includes one less output than the number of neurons in the hidden layer and each neuron is connected to each output. Additionally, each input in the input layer is connected to each neuron in the hidden layer. In other words, input 904a is connected to each of neurons 908a, 908b . . . 908n.

In various implementations, each input node in the input layer may be associated with a numerical value, which can be any real number. In each layer, each connection that departs from an input node has a weight associated with it, which can also be any real number. In the input layer, the number of neurons equals number of features (columns) in a dataset. The output layer may have multiple continuous outputs.

As mentioned above, the layers between the input and output layers are hidden layers. The number of hidden layers can be one or more (one hidden layer may be sufficient for many applications). A neural network with no hidden layers can represent linear separable functions or decisions. A neural network with one hidden layer can perform continuous mapping from one finite space to another. A neural network with two hidden layers can approximate any smooth mapping to any accuracy. The neural network of FIG. 9 can receive inputs, e.g., vectors, which can be used to generate models that can be used, for example, for automated vehicle system requirements elicitation.

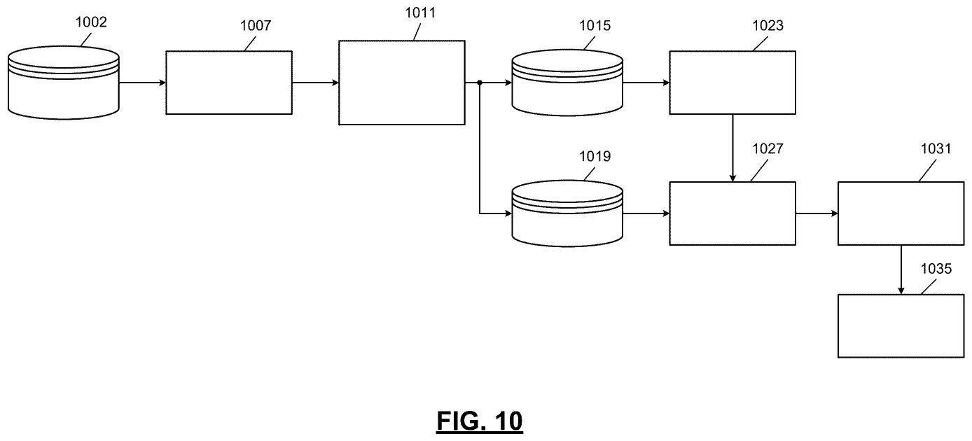

FIG. 10 illustrates an example process for generating a machine learning model. At 1007, control obtains data from a database 1002 (e.g., a data warehouse). The data may include any suitable data for developing machine learning models.

At 1011, control separates the data obtained from the database 1002 into training data 1015 and test data 1019. The training data 1015 is used to train the model at 1023, and the test data 1019 is used to test the model at 1027. Typically, the set of training data 1015 is selected to be larger than the set of test data 1019, depending on the desired model development parameters. For example, the training data 1015 may include about seventy percent of the data acquired from the database 1002, about eighty percent of the data, about ninety percent, etc. The remaining thirty percent, twenty percent, or ten percent, is then used as the test data 1019.

Separating a portion of the acquired data as test data 1019 allows for testing of the trained model against actual output data, to facilitate more accurate training and development of the model at 1023 and 1027. The model may be trained at 1023 using any suitable machine learning model techniques, including those described herein, such as random forest, generalized linear models, decision tree, and neural networks.

At 1031, control evaluates the model test results. For example, the trained model may be tested at 1027 using the test data 1019, and the results of the output data from the tested model may be compared to actual outputs of the test data 1019, to determine a level of accuracy. The model results may be evaluated using any suitable machine learning model analysis, such as the example techniques described further below.

After evaluating the model test results at 1031, the model may be deployed at 1035 if the model test results are satisfactory. Deploying the model may include using the model to make predictions for a large-scale input dataset with unknown outputs. If the evaluation of the model test results at 1031 is unsatisfactory, the model may be developed further using different parameters, using different modeling techniques, using other model types, etc. The machine learning model method of FIG. 10 can receive inputs, e.g., vectors, which can be used to generate models that can be used, for example, for automated vehicle system requirements elicitation.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML 5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A system for automated vehicle control requirements processing, the system comprising:
memory configured to store multiple data artifacts associated with vehicle control system requirements, at least one machine learning model, and computer-executable instructions, wherein the multiple data artifacts include at least two different modalities; and
at least one processor configured to execute the computer-executable instructions to:
preprocess the multiple data artifacts including reducing redundancy among the multiple data artifacts and resolving conflicts between the multiple data artifacts;
determine, for each of the multiple data artifacts, a modality of the data artifact;
create an embedding for each of the multiple data artifacts according to the modality of the data artifact;
generate, as an output of the at least one machine learning model, at least one of a message sequence chart, a finite state machine and a Gherkin use case, according to the embeddings of the multiple data artifacts;
build a unified requirements model according to the at least one of the message sequence chart, the finite state machine and the Gherkin use case, wherein the unified requirements model defines control requirements for at least one vehicle control feature; and
display the unified requirements model on a user interface of a display device.

2. The system of claim 1, wherein the at least one processor is configured to execute the computer-executable instructions to train the at least one machine learning model to output the at least one of the message sequence chart, the finite state machine and the Gherkin use case, based on historical artifact data, using supervised learning.

3. The system of claim 1, wherein the at least one processor is configured to automatically generate computer-executable instructions according to the unified requirements model, to execute the at least one vehicle control feature.

4. The system of claim 1, wherein the at least one processor is configured to execute computer-executable instructions defined according to the unified requirements model, to automatically control acceleration of a vehicle, braking of the vehicle and steering of the vehicle.

5. The system of claim 1, wherein the at least one processor is configured to analyze the unified requirements model using at least one validation tool to identify missing information in the unified requirements model.

6. The system of claim 5, wherein the at least one validation tool includes at least one of:
a message sequence consistency check tool;
a finite state machine analyzer tool; or
a Gherkin output file certifier tool.

7. The system of claim 1, wherein the different modalities of the multiple data artifacts include at least one of:
a text transcript;
a voice recording;
a drawing or image;
a unified modeling language diagram;
a technical specification document;
a process flow diagram; or
a voice of customer feedback verbatim.

8. The system of claim 1, wherein the at least one machine learning model includes a generative artificial intelligence (AI) large language model (LLM).

9. The system of claim 1, wherein creating an embedding for each of the multiple data artifacts includes:
creating a first embedding for a first one of the multiple data artifacts having a first modality, using a first embedding model corresponding to the first modality; and
creating a second embedding for a second one of the multiple data artifacts having a second modality, using a second embedding model corresponding to the second modality.

10. The system of claim 1, wherein generating the output of the at least one machine learning model includes generating the message sequence chart.

11. The system of claim 1, wherein generating the output of the at least one machine learning model includes generating the finite state machine.

12. The system of claim 1, wherein generating the output of the at least one machine learning model includes generating the Gherkin use case.

13. A method for automated vehicle control requirements processing, the method comprising:
preprocessing multiple data artifacts associated with vehicle control system requirements, wherein the multiple data artifacts include at least two different modalities, and the preprocessing includes reducing redundancy among the multiple data artifacts and resolving conflicts between the multiple data artifacts;
determining, for each of the multiple data artifacts, a modality of the data artifact;
creating an embedding for each of the multiple data artifacts according to the modality of the data artifact;
generating, as an output of at least one machine learning model, at least one of a message sequence chart, a finite state machine and a Gherkin use case, according to the embeddings of the multiple data artifacts;
building a unified requirements model according to the at least one of the message sequence chart, the finite state machine and the Gherkin use case, wherein the unified requirements model defines control requirements for at least one vehicle control feature; and
displaying the unified requirements model on a user interface of a display device.

14. The method of claim 13, further comprising training the at least one machine learning model to output the at least one of the message sequence chart, the finite state machine and the Gherkin use case, based on historical artifact data, using supervised learning.

15. The method of claim 13, further comprising automatically generating computer-executable instructions according to the unified requirements model, to execute the at least one vehicle control feature.

16. The method of claim 13, further comprising executing computer-executable instructions defined according to the unified requirements model, to automatically control acceleration of a vehicle, braking of the vehicle and steering of the vehicle.

17. The method of claim 13, further comprising analyzing the unified requirements model using at least one validation tool to identify missing information in the unified requirements model.

18. The method of claim 17, wherein the at least one validation tool includes at least one of:
a message sequence consistency check tool;
a finite state machine analyzer tool; or
a Gherkin output file certifier tool.

19. The method of claim 13, wherein the different modalities of the multiple data artifacts include at least one of:
a text transcript;
a voice recording;
a drawing or image;
a unified modeling language diagram;
a technical specification document;
a process flow diagram; or
a voice of customer feedback verbatim.

20. The method of claim 13, wherein the at least one machine learning model includes a generative artificial intelligence (AI) large language model (LLM).
